(19) United States
(12) Patent Application Publication
(10) Pub. No.: US 2015/0082704 A1
(43) Pub. Date: Mar. 26, 2015

(54) ROLL-UP DOOR SEAL

(71) Applicant: Press-Seal Gasket Corporation, Fort Wayne, IN (US)

(72) Inventors: Jimmy D. Gamble, Garrett, IN (US); Robert R. Slocum, Fort Wayne, IN (US); Graham E. Blackwood, Fort Wayne, IN (US); Katherine A. Bergfeld, Fort Wayne, IN (US)

(21) Appl. No.: 14/502,117

(22) Filed: Sep. 30, 2014

Related U.S. Application Data
(63) Continuation-in-part of application No. 14/012,077, filed on Aug. 28, 2013.
(60) Provisional application No. 61/884,185, filed on Sep. 30, 2013.
(60) Provisional application No. 61/779,336, filed on Mar. 13, 2013.
(60) Provisional application No. 61/697,937, filed on Sep. 7, 2012.

(51) Int. Cl. E06B 7/20; B60J 10/00; E06B 3/34; B62D 65/08; E06B 7/16; E06B 7/23

(52) U.S. Cl. CPC E06B 7/20; E06B 7/16; E06B 7/2314; E06B 3/34; B60J 10/0088; B60J 10/0002
USPC 49/306; 49/489.1; 49/484.1

(57) ABSTRACT

A roll-up door seal arrangement includes side seals, an upper seal and a lower seal to completely seal the periphery of a roll-up door when the door is in a closed position. The seals are sized and adapted to assemble to a standard roll-up door frame without a separate or dedicated frame structure. The seals provide redundant sealing surfaces, positioned to cooperate with both the door and door frame, which ensure an effective and durable fluid tight seal between the cargo space enclosed by the roll-up door and the ambient environment. The seal may be produced by extrusion from a flexible, weather resistant material such as EPDM, thereby providing a low cost solution for sealing roll-up doors having industry standard door frame constructions. The seal is firmly engageable with the door frame, such that the seal may be installed with little or no use of secondary fixation.

### CROSS-REFERENCE TO RELATED APPLICATIONS

This application is a continuation-in-part of U.S. patent application Ser. No. 14/012,077, filed Aug. 28, 2013 and entitled SEAL WITH PRIMARY AND SECONDARY SEALING LOBES FOR USE IN ROLL-UP DOOR APPLICATIONS, which claims the benefit under Title 35, U.S.C. Section 119(e) of U.S. Provisional Patent Application Serial No. 61/779,336, filed Mar. 13, 2013 and entitled ROLL-UP DOOR SEAL and U.S. Provisional Patent Application Serial No. 61/697,937, filed Sep. 7, 2012 and entitled ROLL-UP DOOR SEAL, the entire disclosures of which are hereby expressly incorporated herein by reference. This application claims the benefit under Title 35, U.S.C. §119(e) of U.S. Provisional Patent Application Serial No. 61/884,185, filed on Sep. 30, 2013 and entitled ROLL-UP DOOR SEAL, the entire disclosure of which is hereby expressly incorporated by reference herein.

### BACKGROUND

1. Technical Field

The present disclosure relates to seals, and in particular, to seals that are adapted to seal roll-up type doors, such as cargo vehicle doors, garage and cargo bay doors, etc.

2. Description of the Related Art

Cargo trucks are sometimes provided with “roll-up” type cargo doors which raise and lower to selectively provide access to the cargo space of the truck. Such roll-up doors typically include a series of horizontal door panels hingedly connected to one another such that each panel is pivotable with the respect to the next adjacent panel about a horizontal hinge axis. As the roll-up door is raised, the panels progressively shift from a vertical orientation to a substantially horizontal orientation as the panels move inwardly away from the top of the door frame. To facilitate this function, rollers attached to the roll-up door typically ride within tracks disposed at each side of the door frame, with the tracks running vertically along the sides of the door frame and curving away from the top of the door frame to extend inwardly.

Seals may be provided along either side of roll-up door assemblies to inhibit ingress of water, smoke, particulates, or the like into the cargo space when the roll-up door is closed. In some cases, such seals are affixed to the door frame via fasteners, which may be coupled directly to the body of the seal or to a frame structure built around the seal. These seal arrangements hold a flexible portion of the seal against the outer surface of the roll-up door when the door is in a closed position.

Other roll-up door seals utilize specially designed door frames which accommodate custom-made, correspondingly shaped seal structures. These special seals may fit within the specially designed door frame structure to retain the seal at a desired position and orientation, but are not compatible with standard roll-up door frames or with other custom door frames.

Still other seals utilize multi-density cross-sectional profiles, including a relatively high density seal portion that can be press fit into a seal receiving area of a frame, and a lower density seal portion that is more flexible and bear against the roll-up door when the door is in the closed position. Such seals are typically made from polyvinyl chloride (PVC) with differing durometer values among the different seal portions.

While known roll-up door seals may be effective, it is desirable to minimize the cost and complexity of a roll-up door seal design, while also providing a reliable, long-lasting and fluid-tight seal between the roll-up door and the surrounding environment.

### SUMMARY

The present disclosure provides a roll-up door seal arrangement including side seals, an upper seal and a lower seal to completely seal the periphery of a roll-up door when the door is in a closed position. The seals are sized and adapted to assemble to a standard roll-up door frame without a separate or dedicated frame structure. The seals provide redundant sealing surfaces, positioned to cooperate with both the door and door frame, which ensure an effective and durable fluid tight seal between the cargo space enclosed by the roll-up door and the ambient environment. The seal may be produced by extrusion from a flexible, weather resistant material such as EPDM, thereby providing a low cost solution for sealing roll-up doors having industry standard door frame constructions.

In one form thereof, the present disclosure provides a sealing system for sealing a perimeter of a roll-up door and door frame, the sealing system comprising: a top seal comprising: a coupling portion comprising an upper bridge, an inner leg forming a junction with the upper bridge, and an outer leg forming a junction with the upper bridge opposite the inner leg, such that the inner leg, the outer leg and the upper bridge define a U-shaped door receiving space with an open lower end; an upper sealing lobe extending laterally and upwardly away from the outer leg; and a lower sealing lobe forming a junction with the outer leg and extending laterally and upwardly away from the outer leg, the lower sealing lobe disposed below the upper sealing lobe.

In another form thereof, the present disclosure provides a sealing system for sealing a perimeter of a roll-up door and door frame, the sealing system comprising: a bottom seal comprising: a coupling portion having a coupling surface; a primary sealing lobe extending outwardly from the coupling portion, the primary sealing lobe comprising a primary lobe extension extending upwardly from the primary sealing lobe; a secondary sealing lobe extending inwardly from the coupling portion, the secondary sealing lobe comprising a secondary lobe extension extending upwardly from the secondary sealing lobe.

In yet another form thereof, the present disclosure provides a sealing system for sealing a perimeter of a roll-up door and door frame, the sealing system comprising: a top seal having a resiliently deformable seal lobe; a cable sealing assembly comprising a bracket having a mounting surface and an opposing, arcuate outer surface, the arcuate outer surface adapted to form a continuous sealing arrangement the resiliently deformable seal lobe; and a cable passage area between the mounting surface and the arcuate outer surface.

### BRIEF DESCRIPTION OF THE DRAWINGS

The above-mentioned and other features and advantages of this disclosure, and the manner of attaining them, will become more apparent and the invention itself will be better understood by reference to the following description of an embodiment of the invention taken in conjunction with the accompanying drawings, wherein:

FIG. 1 is a rear perspective view of a cargo truck including a roll-up door fitted with seals made in accordance with the present disclosure;

FIG. 2 is a cross-sectional view of an exemplary seal made in accordance with the present disclosure;

FIG. 3 is a plan, cross-sectional view of the seal shown in FIG. 2, illustrating assembly of the seal to a roll-up door frame;

FIG. 4 is a plan, cross-sectional view, taken along line 3-3 of FIG. 1, illustrating the seal of FIG. 3 after assembly to the roll-up door frame;

FIG. 5 is a plan, cross-sectional view, taken along line 4-4 of FIG. 1, illustrating the seal of FIG. 2 when the roll-up door is in the closed position;

FIG. 6 is a cross-sectional view of another exemplary seal made in accordance with the present disclosure; and

FIG. 7 is a plan, cross-sectional view of the seal shown in FIG. 6, taken along line 4-4 of FIG. 1, illustrating the seal configuration when the roll-up door is in the closed position.

FIG. 8 is a cross-sectional view of yet another exemplary seal made in accordance with the present disclosure;

FIG. 9 is a plan, cross-sectional view of the seal shown in FIG. 8, taken along line 4-4 of FIG. 1, illustrating the seal configuration when the roll-up door is in the closed position;

FIG. 10 is an elevation view of a portion of a roll-up door frame including a seal made in accordance with the present disclosure;

FIG. 11 is a cross-sectional view of a top seal made in accordance with the present disclosure;

FIG. 12 is a cross-sectional view of another exemplary top seal made in accordance with the present disclosure;

FIG. 12A is a cross-sectional view of another exemplary top seal made in accordance with the present disclosure, shown in an as-extruded configuration;

FIG. 12B is a cross-sectional view of another exemplary top seal made in accordance with the present disclosure, shown in a mounted, at-rest configuration;

FIG. 13 is a cross-sectional view of an exemplary bottom seal made in accordance with the present disclosure;

FIG. 13A is a cross-sectional view of an exemplary seal receiving channel for a bottom seal in accordance with the present disclosure;

FIG. 13B is a cross-sectional view of an exemplary bottom seal adapted to be received in the channel of FIG. 13A;

FIG. 14 is an elevation, cross-sectional view of a portion of a roll-up door in a closed position, illustrating the top seal of FIG. 11 shown in a mounted, engaged configuration;

FIG. 15 is an elevation, cross-sectional view of a portion of a roll-up door in a closed position, illustrating the top seal of FIG. 12 shown in a mounted, engaged configuration;

FIG. 15A is an elevation, cross-sectional view of the seal shown in FIG. 15, illustrating airflow interaction therewith;

FIG. 15B is an elevation, cross-sectional view of a portion of a roll-up door in a closed position, illustrating the top seal of FIG. 12A in a mounted, engaged configuration;

FIG. 16 is an elevation, cross-sectional view of a portion of a roll-up door in a closed position, illustrating the bottom seal of FIG. 13 shown in a mounted, engaged configuration;

FIG. 16A is an elevation, cross-sectional view of a portion of a roll-up door in a closed position, illustrating the bottom seal of FIG. 13A shown in a mounted, engaged configuration;

FIG. 16B is a perspective view of a junction between a side and bottom seal in accordance with the present disclosure;

FIG. 17 is a perspective, exploded view of a door cable seal made in accordance with the present disclosure;

FIG. 18A is a perspective view of the cable seal assembly of FIG. 17, shown fully assembled;

FIG. 18B is another perspective view of the cable seal assembly of FIG. 18A; and

FIG. 19 is a perspective view of a portion of an upper frame of a roll-up door, with the cable sealing assembly of FIG. 17 assembled thereto and the top seal of FIGS. 12 and 15 engaged therewith.

Corresponding reference characters indicate corresponding parts throughout the several views. The exemplification set out herein illustrates an exemplary embodiment of the invention, and such exemplification is not to be construed as limiting the scope of the invention in any manner.

### DETAILED DESCRIPTION

1. Side Seals

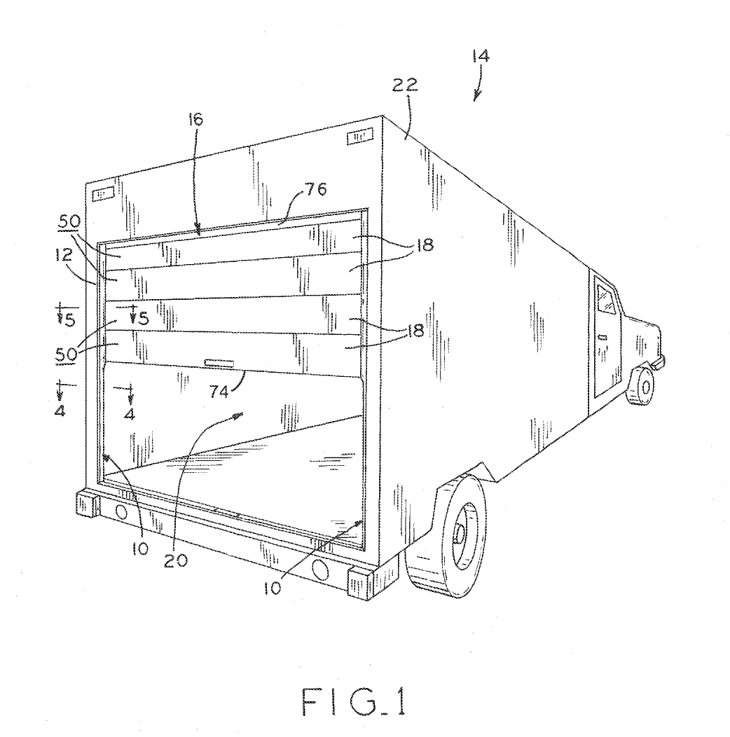

Turning now to FIG. 1, seals 10 are shown installed at either side of roll-up door frame 12, which is positioned at the rear of cargo box 22 mounted to truck 14. Seals 10 may be identical structures, but are arranged as mirror images of one another so as to have main sealing lobes 40 extending inwardly toward cargo space 20, as described in further detail below. Roll-up door 16, sometimes also referred to as an overhead door, includes a plurality of door panels 18 hingedly connected to one another such that each door panel 18 is pivotable about a horizontal axis. In the illustrated embodiment of FIG. 1, roll-up door 16 is shown in a partially closed configuration, with seals 10 partially deformed into a sealing configuration in the area where roll-up door 16 is closed.

When door 16 is open, cargo space 20 is accessible through the aperture defined by door frame 12, and door panels 18 are disposed within cargo box 22 such that door panels 18 are all substantially parallel to the roof of cargo box 22. In the closed configuration, door panels 18 of roll-up door 16 are vertically oriented (as shown in FIG. 1 with respect to some of the panels 18), such that roll-up door 16 blocks access to cargo space 20 from outside cargo box 22. As described in detail below, seals 10 bear against outer surfaces 50 of door panels 18 to provide a fluid tight seal between cargo space 20 of cargo box 22 and the surrounding environment.

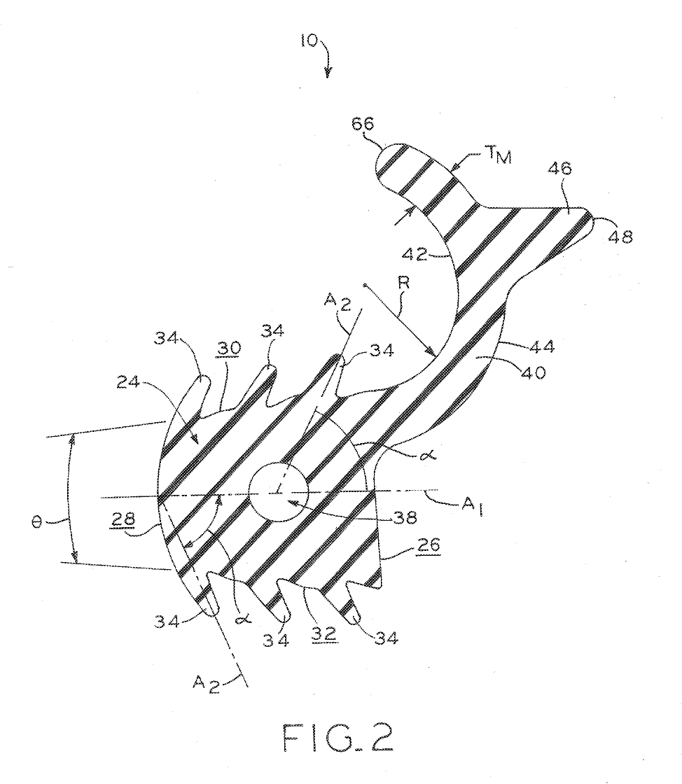

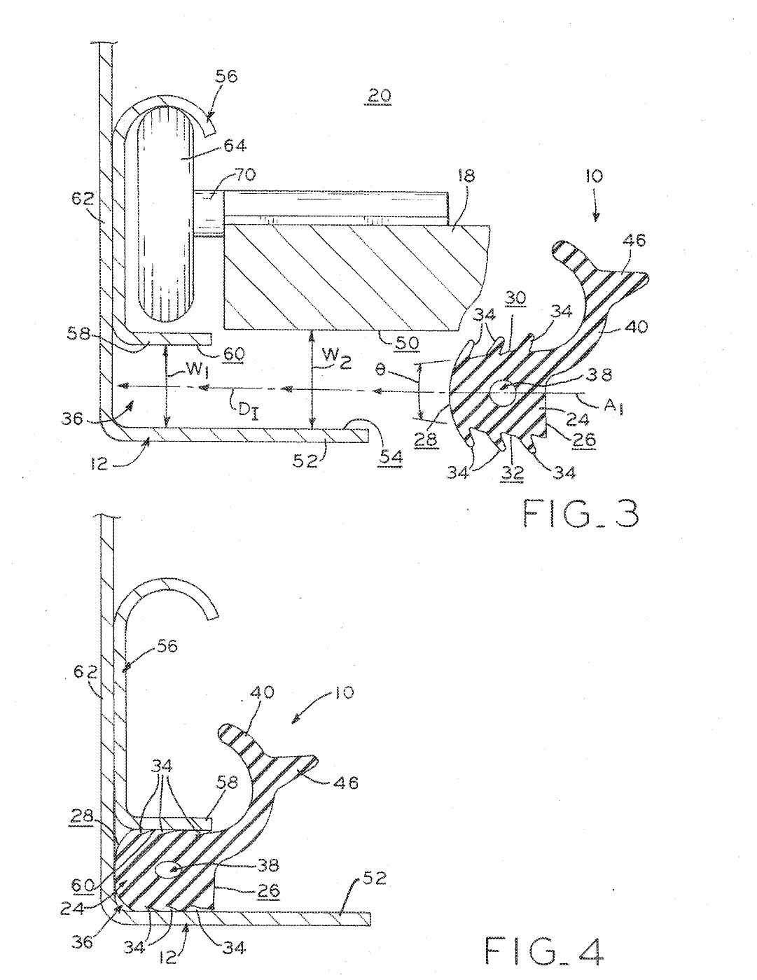

FIG. 2 illustrates a cross-sectional profile of seal 10 in an uncompressed state, after manufacture and prior to installation within door frame 12 (FIG. 3). Seal 10 includes coupling body 24 defining longitudinal axis A₁, which may also be an axis of symmetry for coupling body 24. Axis Aₗ extends along insertion direction D_{I}, shown in FIG. 3, which is the direction of assembly of seal 10 to door frame 12, as described in further detail below. Coupling body 24 tapers along axis A₁ from exposed surface 26 toward seating surface 28, such that side surfaces 30, 32 define angle θ therebetween. As illustrated, angle θ is measured without taking into account securement ribs 34, which extending outwardly from each of side surfaces 30, 32. In an exemplary embodiment, angle θ may be as little as zero, 5 or 10 degrees or may be as large as 20, 25 or 30 degrees, or may be any value within any range defined by any of the foregoing values. In one particular exemplary embodiment, angle θ is about 4 degrees.

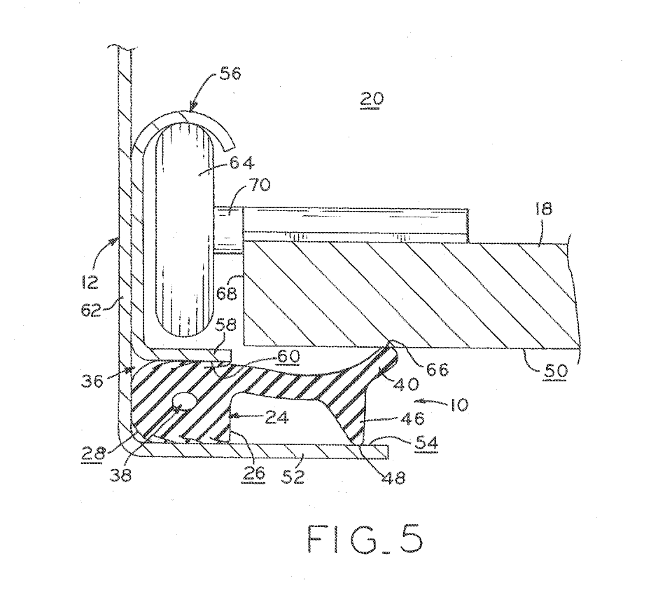

Seating surface 28 has a generally rounded profile, as shown in FIG. 2, to further facilitate initial insertion of coupling body 24 into seal receiving space 36. Exposed surface 26, disposed opposite seating surface 28, is substantially flat (i.e., planar) to facilitate flush mounting with the adjacent edge of a flange 58 of roller track 56, as shown in FIGS. 4 and 5 and described in further detail below.

Securement ribs 34 are elongate structures as viewed in the cross section of FIG. 2, and therefore each define a longitudinal axis A₂. Each axis A₂ forms an acute angle α with respect to axis A₁ of coupling body 24, with each of securement ribs 34 configured such that angle α opens away from insertion direction D_{I} and toward exposed surface 26 of coupling body 24. As described in further detail below, this configuration allows securement ribs 34 to easily deform when coupling body 24 is seated within seal receiving space 36 (FIGS. 3 and 4), while also resisting removal of coupling body from seal receiving space 36. In the interest of drawing clarity, the longitudinal axis A₂ of securement ribs 34 is shown for only one of securement ribs 34 on each of side surfaces 30, 32, it being understood that the other securement ribs 34 also define respective axes A₂ forming angle α with respect to the longitudinal axis A₁ of coupling body 24. In an exemplary embodiment, angle α may be as little as 45, 55 or 65 degrees or may be as large as 75, 85 or 90 degrees, or may be any value within any range defined by any of the foregoing values. In one particular exemplary embodiment, angle α is about 67 degrees.

In the illustrated embodiment of FIG. 2, three securement ribs 34 are provided on each of side surfaces 30, 32. However, it is contemplated that a larger or smaller number of ribs 34 may be provided to decrease or increase the securement of coupling body 24 within seal receiving space 36, respectively, as required or desired for a particular application. In an exemplary embodiment, securement ribs 34 are sized and spaced from one another such that each of securement ribs can deform or “fold” down, in the direction of exposed surface 26 of coupling body 24) to abut the adjacent side surface 30 or 32 upon installation of seal 10. Aperture 38 may also be formed within coupling body 24 to facilitate deformation thereof during installation of seal 10, as also described below.

Extending away from exposed surface 26 is main sealing lobe 40, as best seen in FIG. 2. As illustrated, main sealing lobe 40 has a generally arcuate profile in cross-section, with an inner surface 42 forming an arcuate continuation of side surface 30. When seal 10 is assembled to door frame 12, side surface 30 is the inwardly facing surface of coupling body 24, i.e., the surface facing toward the enclosed cargo space 20 of cargo box 22. Thus, the illustrated position and arrangement of main sealing lobe 40 near inward side surface 30 biases sealing lobe 40 toward door panels 18 when roll-up door 16 is positioned closed, as shown in FIG. 5 and further described below.

Opposite inwardly facing surface 42 of main sealing lobe 40 is outwardly facing surface 44, which has secondary sealing lobe 46 protruding therefrom. In the illustrative embodiment of FIG. 2, main sealing lobe 40 has a substantially constant thickness T_{M} throughout its arcuate extent, while secondary sealing lobe 46 has a generally triangular profile with a steadily decreasing thickness from the wide base of sealing lobe 46 (at its intersection with main sealing lobe 40) to the narrower tip 48 of secondary sealing lobe 46 (i.e., the point on sealing lobe 46 furthest from outer surface 44 of main sealing lobe 40).

Assembly of seal 10 to door frame 12 is illustrated in FIG. 3. Seal 10 is received within seal receiving space 36 such that main sealing lobe 40 is positioned to bear against door panel 18 while secondary sealing lobe 46 bears against an inner surface 54 of flange 52 of door frame 12. Seal receiving space 36 is a generally rectangular void (as viewed in the plan cross-sectional view of FIG. 3), bounded on three sides by structures of door frame 12 and open on the fourth side. Opposite the open end of seal receiving space 36, sidewall 62 of door frame 12 forms the “bottom” or base of seal receiving space 36, against which seating surface 28 bears upon assembly of seal 10 to door frame 12 (FIG. 4). Flange 58 of roller track 56 forms an inward wall of seal receiving space 36, while flange 52 of door frame 12 forming the opposing outward wall.

In certain exemplary embodiments, roller track 56 is fixedly attached to door frame 12, such as by welding, riveting or other fixed attachment, such that a plurality of rollers 64 connected to door panels 18 via axles 70 ride within roller track 56 as door 16 is raised and lowered (FIG. 1). Door frame 12 may be provided in a standard size and arrangement with roller track 56 affixed thereto in a standard configuration to accommodate mass produced roll-up doors 16 and rollers 64.

Seal receiving space 36 defines width W₁ between outwardly facing surface 60 of track flange 58 and the opposing inwardly facing surface 54 of frame flange 52. In an exemplary embodiment in the context of roll-up cargo truck doors (such as door 16 shown in FIG. 1), width W₁ may be between 0.5 inches and 1 inch. For other applications in other contexts, the overall profile shown and described herein may be scaled up or down to provide seals usable for other door frame sizes. In one exemplary embodiment, door frame 12 defines width W₁ of 0.88 inches, and the corresponding width of body 24 of seal 10 is about 0.74 inches wide at seating surface 28 and 0.82 inches wide at exposed surface 26. In this exemplary embodiment, securement ribs are each between 0.06 inches and 0.1 inches wide, and are about 0.25 inches long as measured along axis A₂. In this exemplary embodiment, the overall length of seal 10 (corresponding to the height of the sides of door frame 12 and shown in FIG. 1) may be about 110 inches.

As noted below, seal 10 may be provided in one or more standard sizes to accommodate various industry standard geometries for door frame 12. More particularly, body 24 of seal 10 may be sized and configured to be received within a standard size seal receiving space 36, while main sealing lobe 40 and secondary sealing lobe 46 are sized and configured to occupy the space between frame flange 52 and door panels 18. As further described below, lobes 40, 46 may be specifically arranged to fill in a gap having width W₂ between outer surface 50 of door panel 18 and inwardly facing surface 54 of frame flange 52, while providing a secure sealing arrangement therewithin.

Assembly of seal 10 to door frame 12 along insertion direction D_{I} (FIG. 3) can be accomplished quickly and efficiently. In an exemplary assembly method, body 24 of seal 10 is advanced along insertion direction D_{I} such that seating surface 28 of body 24 forms the leading edge of seal 10 advancing into seal receiving space 36. The rounded outer profile of seating surface 28 facilitates initial insertion between flange 58 of roller track 56 and flange 52 of door frame 12. As coupling body 24 is further advanced along insertion direction D_{I}, the first pair of securement ribs 34 (i.e., those securement ribs 34 which are closest to seating surface 28) deflect toward side surfaces 30, 32, respectively. This initial deflection is facilitated by the tapered profile of side surfaces 30, 32, which cooperate to define angle θ (FIG. 3) therebetween.

Further advancement of coupling body 24 along direction D_{I} into seal receiving space 36 deflects the remaining securement ribs 34 as respective pairs of ribs 34 come into contact with frame flange 52 and track flange 58. As the width between side surfaces 30, 32 increases along the tapered outer profile of body 24, body 24 is more and more tightly received within seal receiving space 36. To accommodate the eventual interference fit between such wider body portions and seal receiving space 36, aperture 38 may compress from a circular to ellipsoid configuration as shown in FIG. 4.

In one exemplary embodiment, width W₁ is equal to about 0.88 inches. As noted above, the corresponding width of body 24 for this exemplary embodiment is about 0.74 inches at seating surface 28, excluding the adjacent securement ribs 34, which facilitates initial insertion of body 24 into seal receiving space 36. However, the final width of body 24 adjacent exposed surface 26 is about 0.82 inches, which cooperates with the about 0.1 inch thick securement ribs 34 to create an interference fit. Thus, the material of body 24 must be deformed to fully seat body 24 within seal receiving space 36. When body 24 is fully received within seal receiving space 36, seating surface 28 contacts sidewall 62 of door frame 12, all of securement ribs 34 are deflected toward their respective side surfaces 30, 32, coupling body 24 is slightly compressed such that aperture 38 is slightly deformed, and exposed surface 26 is substantially flush with the edge of track flange 58. This fully assembled configuration is illustrated in FIG. 4.

Although body 24 may be easily received within seal receiving space 36, a much greater force is required to remove body 24 therefrom. This insertion/removal force differential results from the orientation of securement ribs 34 with respect to longitudinal axis A₁ of coupling body 24, and therefore with respect to insertion direction D_{I} (FIG. 3).

More particularly, as noted above, securement ribs 34 each define acute angle α with respect to longitudinal axis A₁, such that angle α opens away from seating surface 28 and toward exposed surface 26. Upon insertion of coupling body 24 into seal receiving space 36, this angular arrangement allows securement ribs 34 to deflect toward exposed surface 26 easily and with minimal frictional resistance. However, if coupling body 24 is pulled along a removal direction opposite insertion direction D_{I}, securement ribs 34 bear against inwardly facing surface 54 of frame flange 52 and outwardly facing surface 60 of track flange 58, respectively. Along this removal direction, angle α defined by securement ribs 34 serves to urge securement ribs 34 to expand away from side surfaces 30, 32, respectively, rather than urging ribs 34 toward contact therewith. This expansion effectively increases the overall width of coupling body 24, thereby increasing the level of friction between coupling body 24 and surfaces 54, 60 of flanges 52, 58, respectively.

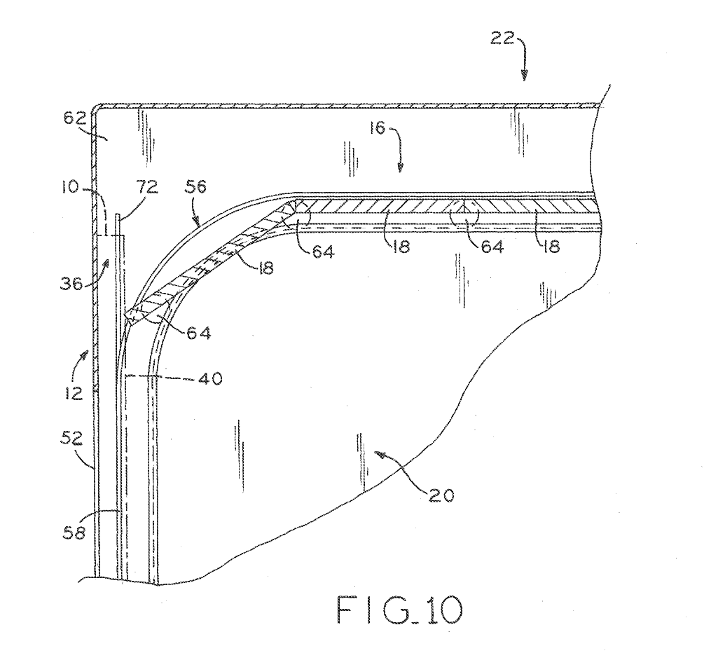

Thus, the force required to remove coupling body 24 from seal receiving space 36 is substantially higher than the force required to insert coupling body 24 into seal receiving space 36 along insertion direction D_{I}. This force differential allows seal 10 to be effectively used in conjunction with door frame 12 with little or no use of adhesives, fasteners, or other secondary fixation. Using only the material of coupling body 24, firm securement of seal 10 to door frame 12 can be effected by pushing the coupling body 24 into the seal receiving space 36. In the exemplary embodiment shown in FIG. 10, for example, only the top portion of seal 10 (i.e., the portion near the curved portion of roller track 56) is secured within door frame 12 by secondary fixation, such as adhesive. The remainder of seal 10 extending downwardly below such curved portion may be secured only by interaction between coupling body 24 and seal receiving space 36.

In one exemplary embodiment, seal 10 is monolithically formed from EPDM (ethylene propylene diene monomer) rubber having durometer 55. In other exemplary embodiments, the durometer of the seal material may be as little as 40, 50 or 60 or may be as large as 65, 75 or 85, or may be any value within any range defined by any of the foregoing values. EPDM rubber is highly resistant to degradation from weather and sun, while also being sufficiently soft and pliable to create an effective seal between cargo space 20 of cargo box 22 and the surrounding ambient environment. Accordingly, this material has proven ideal for use with roll-up doors used in cargo trucks and other demanding outdoor environments.

In the installed configuration of FIG. 4, main sealing lobe 40 and secondary sealing lobe 46 remain in their undeformed state due to the absence of roll-up door 16 at the location of the FIG. 4 cross-section (as shown in FIG. 1). As roll-up door 16 is advanced from the open to closed position, sealing lobes 40, 46 are progressively deformed into a sealing configuration along the extent of seal 10. In an exemplary embodiment shown in FIG. 10, roll-up door frame 12 includes extension 72, which abuts and aligns with outwardly facing surface 50 of roller track 56 to extend seal receiving space 36 upwardly past the point where track flange 58 of roller track 56 begins its inward bend into cargo space 20. This effective lengthening of seal receiving space 36 allows seal 10 to be made longer and to extend substantially above the initial inward bend of roller track 56, such that the first point of contact between the leading edge of door panel 18 and main sealing lobe 40 is substantially spaced away from the end of seal 10. This in turn prevents sealing lobe 40 from “folding over” upon first contact by panel 18 of door 16, and promotes proper deformation of lobe 40 into its sealing configuration as described in further detail below.

After initial deformation of sealing lobe 40, outer surfaces 50 of door panels 18 successively come into contact with tip 66 of main sealing lobe 40 further and further down the length of seal 10. This “zipper” effect progressively forces lobe 40 outwardly (i.e., in a direction away from cargo space 20 of cargo box 22), which in turn advances tip 48 of secondary sealing lobe 46 into contact with inwardly facing surface 54 of frame flange 52 as illustrated in FIG. 5. Lobes 40, 46 are sized and configured to occupy a space between door panel 18 and frame flange 52 that is slightly larger than width W₂, such that slight compression and deformation of lobes 40 and 46 occurs. This compression forms a pair of firm, fluid-tight seals between cargo space 20 and the ambient environment around cargo box 22.

Because lobes 40, 46 are forcibly deformed into their sealing configurations shown in FIG. 5, the resiliency of the material of seal 10 serves to bias tips 66, 48 of lobes 40, 46 toward contact with their respective sealing surfaces 50, 54. This spring-like bias force maintains the redundant pair of fluid-tight seals formed by seal 10, even if movement or vibration of door panels 18 and/or door frame 12 occurs (such as while truck 14 is moving). Moreover, the deformation of main sealing lobe 40 serves to “push” secondary sealing lobe 46 into its sealing arrangement, which in turn “pushes back” against main sealing lobe 40. In this way, sealing lobes 40, 46 act as mutually opposed biasing elements urging one another into sealing contact with their mutually opposed sealing surfaces 50, 54 respectively. Such biased contact between lobes 40, 46 and the adjacent sealing surfaces 50, 54 ensures that a lasting, durable fluid-tight seal will form even as the material of seal 10 becomes weathered over time.

The amount of bias force provided by main sealing lobe 40 toward outer surface 50 of door panel 18 can be raised or lowered by changing the size and geometry of lobe 40. For example, thickness T_{M} (FIG. 2) may be increased to elevate the biasing force, or decreased to reduce the biasing force. In an exemplary embodiment designed for a seal receiving space 36 having width W₁ of 0.88 inches and a door frame arrangement defining width W₂ of 0.688 inches (with a tolerance of +/−0.063 inches), thickness T_{M} is 0.19 inches.

Another variable affecting the biasing force is the undeformed radius of curvature R defined by lobe 40 (shown in FIG. 2 as radius R at inwardly facing surface 42). If radius R is increased, the biasing force will decrease because the amount of material deformation will be reduced. Conversely, a decrease in radius R will cause an increase in material deformation and a concomitant increase in biasing force. As biasing force increases, sealing deformation and the ability of lobe 40 to span width W₂ increases. In the exemplary embodiment discussed above, radius R is about 0.5 inches. In the exemplary embodiments shown in FIGS. 6-9 and described in detail below, radii R₁₀₀, R₂₀₀ are 2.3 about inches. For larger or smaller seal arrangements, such as those having larger or smaller width W₂, the overall size of lobe 40 will increase accordingly. However, the overall thickness of lobe 40 may remain substantially constant.

Similarly, secondary sealing lobe 46 may be changed in size and thickness to provide greater or lesser biasing force against inwardly facing surface 54 of frame flange 52. In the exemplary embodiment referenced above for a width W₁ of 0.88 inches for seal receiving space 36 and width W₂ of 0.688 to 0.748 inches, lobe 46 may extend an appropriate distance away from outwardly facing surface 44 of lobe 40, measured as the shortest distance from the extrapolated outer surface 44 to the end of tip 48 of lobe 46. In the case of seal 10, this distance may be about 0.5 inches. Lobe 46 may also define an overall width at the base thereof equal to about 0.38 inches. The overall length and/or width dimensions can be increased to increase the biasing force provided by lobe 46, or may be decreased to decrease such biasing force. Although lobe 46 is shown as being made of solid material in FIGS. 2-5, an aperture may be provided therein to reduce the biasing force provided by lobe 46.

In an exemplary embodiment, lobes 40 and 46 of seal 10 are designed to provide a high enough level of biasing force against their respective sealing surfaces 50, 54 to create a reliably fluid-tight seal, while being low enough to prevent undue friction against door panels 18. In this embodiment, the appropriate level of biasing force can be calculated within a range of forces that both a) reliably creates a fluid-tight seal and b) results in a friction force sufficiently low to allow the user of roll-up door 16 to manually open and close roll-up door 16.

As illustrated in FIG. 5, when door 16 is in the closed position tip 66 extends laterally toward the middle of door panel 18 by a substantial distance, i.e., the distance between exposed surface 26 and tip 66 of lobe 40. In the exemplary embodiment described above adapted for use with a seal receiving space 36 having width W₁ of 0.88 inches, this lateral distance may be about 1.5 inches or more. This allows seal 10 to reliably bias against outer surface 50 of door panel 18, even if lateral edge 68 (FIG. 5) of door panels 18 of door 16 are variably spaced from sidewall 62 of door frame 12. For example, in some standard roll-up door designs, axle 70 of rollers 64 may be longer or shorter than in other standard designs, thereby changing the lateral position of edge 68 of door panels 18. In other cases, rollers 64 (and therefore door panels 18) are allowed to shift laterally within roller track 56 as the roll-up door 16 opens or closes. Such lateral shifting may be significant, such as up to 0.5 inches in either lateral direction. Seal 10, with its long sealing lobe 40, is usable on all such standard door frame designs despite variations in the exact size and configuration, and potential lateral shift of the corresponding roll-up door.

As described above, seal 10 may be installed quickly and efficiently without tools, and with little or no use of adhesives or other secondary fixation structures. Coupling body 24 is simply advanced laterally, i.e., along direction D_{I} (FIG. 3) such that the installer standing near cargo box 22 passes seal 10 toward sidewall 62 of frame 12. This lateral advancement is complete when coupling body 24 is fully received within seal receiving space 36. When so installed, coupling body 24 is captured within seal receiving space 36, as discussed in detail above, and sealing lobes 40, 46 protruded outwardly from seal receiving space 36. In one exemplary embodiment, such installation may be effected without fasteners or adhesives. In another exemplary embodiment, a minimal amount of such auxiliary coupling aids is used, such as at the top of seal 10 as described above. Seal 10 is installed along its length such that the sides of door frame 12 are completely sealed.

To uninstall seal 10, seal 10 can be simply grasped (e.g., by sealing lobe 40) and pulled free from seal receiving space 36 and door frame 12. Although seal 10 requires an elevated amount of force to remove from seal receiving space 36, such force can be marshaled by a maintenance person when needed to uninstall and replace seal 10. Such uninstallation is simplified by the minimal use (or lack of) fasteners and adhesives used in the initial installation. Thus, seal 10 may be readily replaced whenever such replacement becomes necessary. Moreover, because seal 10 can be made from a single, monolithic extruded material as detailed above, replacement seals 10 can be produced in large quantities for a minimal cost.

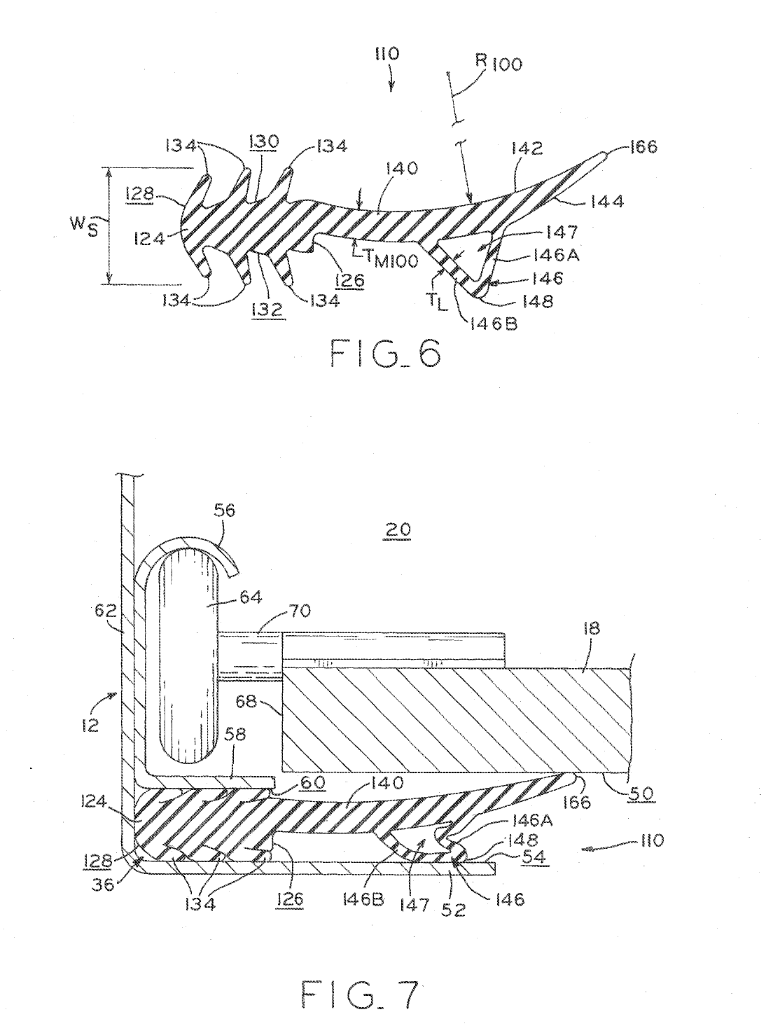

Turning now to FIG. 6, a cross-sectional profile of alternative seal 110 is shown. Seal 110 is similar to seal 10 described above, with reference numerals of seal 110 analogous to corresponding reference numerals used in seal 10, except with 100 added thereto. Structures of seal 110 correspond to similar structures denoted by corresponding reference numerals of seal 10 except as otherwise noted, and seal 110 is installed to door frame 12 in a similar fashion as described above (and as shown in FIG. 7).

However, coupling body 124, main sealing lobe 140 and secondary sealing lobe 146 of seal 110 have unique geometries which provide seal 110 with unique sealing characteristics. Coupling body 124 has a narrower overall narrower profile but with longer securement ribs 134 extending therefrom. This arrangement allows for more pronounced deformation of securement ribs 134 upon assembly into seal receiving space 36 (as shown in FIG. 7), and obviates the need for aperture 38 used in seal 10 (FIG. 2). Also, as most clearly illustrated by a comparison of FIGS. 5 and 7, the overall length of seal 110 is also substantially longer than that of seal 10. In an exemplary embodiment, the largest cross-sectional dimension of seal 110 in the undeformed state of FIG. 6 is about 2.73 inches. The overall undeformed width W_{S} of coupling body 124 is about 0.71 inches, such that seal 110 is suitable for use in door frame 12 having a width W₁ of seal receiving space 36 (FIG. 3) equal to 0.5 inches.

Main sealing lobe 140 has a substantially reduced curvature in its at-rest, undeformed state as shown in FIG. 6. Accordingly, radius R₁₀₀ defined by the concave cross-sectional profile of inner surface 142 of lobe 140 is substantially larger than radius R of lobe 40 of seal 10. As noted above, such a reduction in the curvature of lobe 140 as compared to lobe 40 produces less biasing force against outer surface 50 of door panels 18 when seal 110 is in its sealing, deformed state (FIG. 2). Concomitantly, less friction is produced at the area of contact between tip 166 and outer surfaces 50 of respective door panels 18 of roll-up door 16. For certain exemplary embodiments, such as roll-up doors commonly found on the rear enclosures of cargo trucks, the large-radius arrangement shown in FIG. 6 has been found to provide a firm, liquid-tight seal while preventing undue friction.

Main sealing lobe 140 also lacks the constant thickness T_{M} found in lobe 40 of seal 10 (FIG. 2). Instead, lobe 140 defines a relatively constant thickness T_{M100} (FIG. 6) between exposed surface 126 and secondary sealing lobe 146, then a tapering thickness between secondary sealing lobe 146 and tip 166 (where tip 166 is at the end of the longitudinal extent of lobe 140, opposite exposed surface 126 as shown in FIG. 6). Stated another way, the shortest distance between concave inner surface 142 and the opposing, convex outer surface 144 of sealing lobe 140 steadily decreases as one traverses the longitudinal extent of main sealing lobe 140 from secondary sealing lobe 146 to tip 166.

Secondary sealing lobe 146 retains the generally triangular profile found in secondary sealing lobe 46 of seal 10, but is more nearly equilateral in overall shape and has aperture 147 formed therein. As shown in FIG. 7, when seal 10 enters its sealing configuration with respect to door panel 18, secondary sealing lobe 146 substantially deforms to create a liquid-tight seal with inwardly facing surface 54 of flange 52 of door frame 12. More particularly, a first lobe wall 146A, extending from toward tip 166 of main sealing lobe 140, resiliently deforms into a “buckled” configuration, as shown in FIG. 7, when tip 148 of lobe 146 (i.e., the point on sealing lobe 146 furthest from outer surface 144 of main sealing lobe 140) is urged into contact with inwardly facing surface 54. This buckling causes first lobe wall 146A to protrude into aperture 147 as illustrated, so that tip 148 of secondary sealing lobe 146 deflects in an opposite direction to that of tip 166 of main sealing lobe 140.

The resiliency of the material of first lobe wall 146A, i.e., the tendency of first lobe wall 146A to return to its undeformed configuration, provides a constant biasing force urging main sealing lobe 140 toward outer surface of door panel 18. This force biases lobe tip 166 into sealing engagement with surface 50, in similar fashion as described above with respect to seal 10. Meanwhile second lobe wall 146B, which is located opposite first lobe wall 146A and extends toward coupling body 124 as shown, is urged into sealing contact with inner surface 54 of flange 52 by the resilient deformation of main sealing lobe 140, such that lobes 140, 146 bias each other into sealing engagement. In addition, the extended sealing contact of second lobe wall 146B across a substantial portion of second lobe wall 146B, such as about half of its cross sectional extent as illustrated, providing a reliably liquid-tight seal at surface 54. In an exemplary embodiment, the above-described sealing action can be achieved with a lobe wall thickness TL (FIG. 6) of about 0.07 inches.

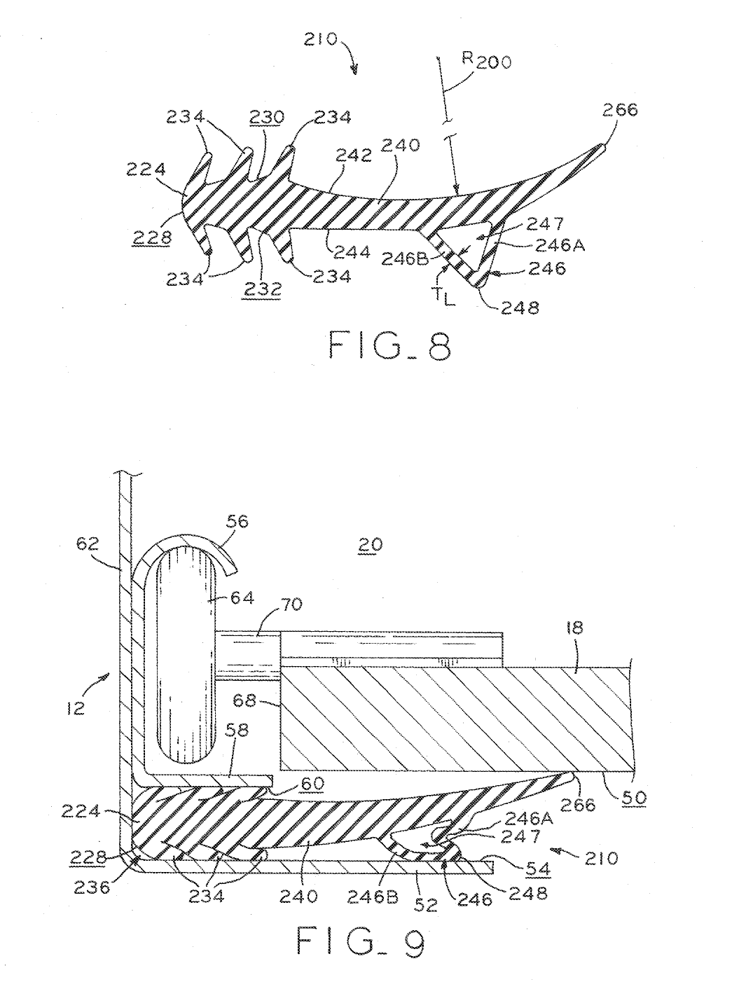

Turning to FIGS. 8 and 9, a cross-sectional profile of another alternative seal 210 is shown. Seal 210 is similar to seals 10, 110 described above, with reference numerals of seal 210 analogous to corresponding reference numerals used in seal 10, 110, except with 100 or 200 added thereto respectively. Structures of seal 210 correspond to similar structures denoted by corresponding reference numerals of seals 10, 110 except as otherwise noted, and seal 210 is installed to door frame 12 in a similar fashion as described above (and as shown in FIG. 9).

In an exemplary embodiment, seal 220 is identical to seal 120 except at the junction between main sealing lobe 240 and coupling body 224. More particularly, seal 220 lacks the constant-thickness section found main sealing lobe 140 (i.e., that portion of sealing lobe 140 having thickness T_{M100}) and instead has a steadily increasing thickness toward coupling body 224. As above, this thickness is measured as the shortest distance from concave inner surface 242 to convex outer surface 244, taken along any point along the longitudinal extent of the illustrated cross-section of sealing lobe 240. As illustrated, this arrangement eliminates any analog to exposed surfaces 26, 126 in seal 210, with convex outer surface 244 of main sealing lobe 240 instead blending smoothly with side surfaces 232 of coupling body 224. This profile enhances the strength of the connection between lobe 240 and coupling body 224, and provides some additional biasing force to tip 266 of lobe 240.

Referring back to FIG. 1, bottom seal 74 and/or top seal 76 may also be provided as needed to complete liquid-tight seal around roll-up door 16. Bottom and/or top seals 74, 76 may be used in a known configuration, except that the ends of bottom seal 74 may be trimmed as necessary to accommodate seals 10, 110 or 210 on either side of door 16.

2. Top Seal

Turning now to FIG. 11, an exemplary top seal 76A is illustrated in cross-section. Seal 76A may be a monolithic, uniform extruded or cast part, similar to side seals 10, 110, 210, and may be cut to an appropriate length to span the upper portion of roll-up door 16 (FIG. 1).

Except as otherwise described below, top seal 76A has a number of features similar to seals 10, 110, 210 described above, and reference numerals of seal 76A are analogous to corresponding reference numerals used in seals 10, 110, 210 except with 300, 200 or 100 added thereto respectively. Structures of seal 76A correspond to similar structures denoted by corresponding reference numerals of seals 10, 110, 210 except as otherwise noted.

However, unlike side seals 10, 110 and 210, top seal 76A utilizes different coupling structures for mounting seal 76A to roll-up door 16 (rather than to door frame 12), and utilizes differently shaped and arranged sealing lobes to effect redundant sealing surfaces between door frame 12 and the upper-most panel 18 of door 16 when door 16 is in the closed position.

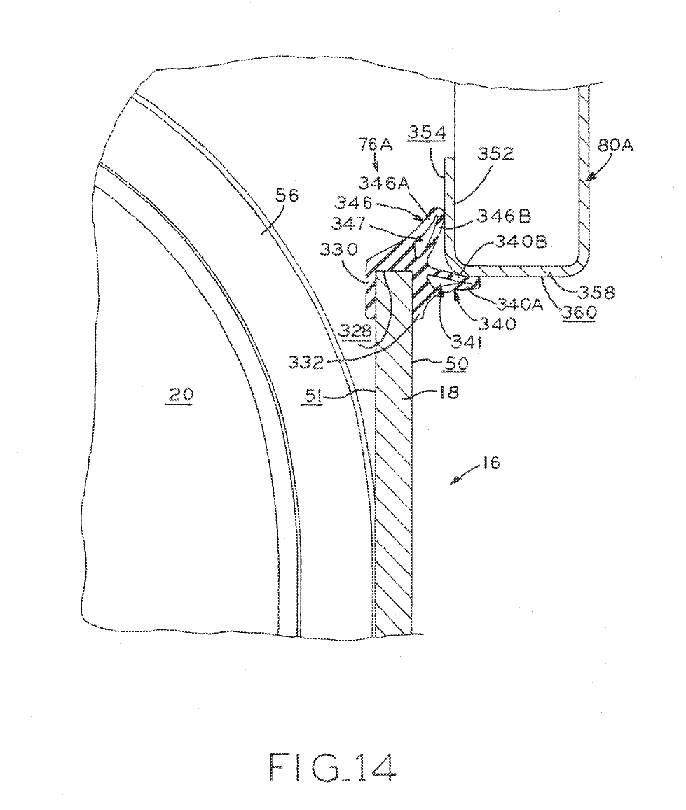

Referring still to FIG. 11, top seal 76A includes inner leg 330 and outer leg 332, both of which extend downwardly in substantially parallel fashion when seal 76A is mounted to door panel 18 (as shown in FIG. 14 and described in detail below). Door seating surface 328 spans the distance D between legs 330, 332 such that legs 330, 332 and seating surface 328 all cooperate to define coupling recess 324 which is sized and configured to receive an upper edge of door panel 18. In an exemplary embodiment, legs 330, 332 may define an at-rest, undeformed state in which legs 330, 332 converge toward one another as legs 330, 332 extend downwardly away from seating surface 328, such that one or both of legs 330, 332 may elastically deform to conform to the upper edge of door panel 18 and thereby resiliently grip the door edge. In this way, seal 76A may be firmly affixed to door panel 18, rendering the use of additional adhesives or other fixation devices optional. As shown in FIG. 14, when seal 76A is fully installed upon door panel 18, the upper edge of the upper-most door panel 18 of door 16 abuts seating surface 328, while outer leg 332 abuts outer surface 50 and inner leg 330 abuts the opposing inner surface 51 of door panel 18.

Seal 76A includes a primary sealing lobe 340 and a secondary sealing lobe 346. Similar to the corresponding lobe structures of side seals 10, 110, 210 described above, primary sealing lobe 340 provides an outer barrier to fluid ingress into cargo space 20. This barrier is formed by sealing engagement of upper portion 80A of door frame 12 with lobe 340 when door 16 is in the closed position, as described further below. Seal 76A also includes secondary sealing lobe 346 which provides a second, redundant fluid-tight seal disposed between cargo space 20 and primary sealing lobe 340, such that a further barrier against ingress of fluid or other contaminants into cargo space 20 is provided in addition to primary lobe 340.

Primary sealing lobe 340 includes outer and inner lobe walls 340A, 340B which, in cooperation with outer leg 332, define aperture 341 extending through lobe 340. As shown in FIG. 14, when door 16 is in the fully closed position (i.e., when the upper-most door panel 18 is a generally vertical orientation along with the remaining panels 18 of door 16), primary lobe 340 resiliently deforms to seal against horizontal flange 358 of upper portion 80A of door frame 12. More particularly, an inner surface of inner lobe wall 340B abuttingly engages downwardly facing surface 360 of horizontal flange 358, while also partially compressing aperture 341 as lobe 340B moves toward 340A. Lobe 340A may also partially deform, as illustrated.

In use, as upper panel 18 of door 16 moves toward a closed position while rollers 64 ride through roller track 56 (see e.g., FIG. 7), outer lobe wall 340A makes initial contact with upper frame portion 80A. As upper door panel 18 continues to move downwardly and pivot toward a vertical orientation from a horizontal orientation, lobe 340 “pops” or “rolls” from a first deformed state in which outer lobe wall 340A abuts vertical flange 352 of upper frame portion 80A into the sealing configuration shown in FIG. 14 in which inner lobe wall 340B abuttingly engages horizontal flange 358.

Secondary sealing lobe 346 comes to rest against vertical flange 352 when door 16 is in the fully closed position, as shown in FIG. 14. Specifically, outer sealing lobe 346B comes into abutting contact with inwardly facing surface 354 of vertical flange 352, which in turn resiliently deforms outer and inner sealing lobes 346B, 346A and compresses aperture 347 in similar fashion to the sealing deformation of aperture 341.

In this way, top seal 76A provides a dual-contact, redundant sealing engagement with upper frame portion 80A along two different flanges thereof, in which the two different flanges are angled (e.g., at right angles), as illustrated in FIG. 14.

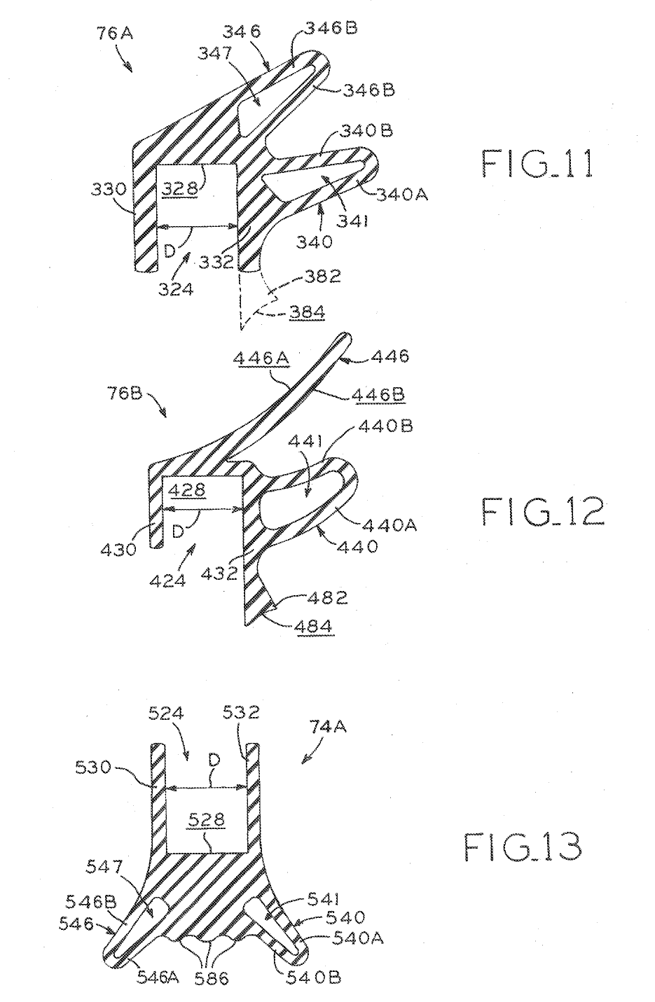

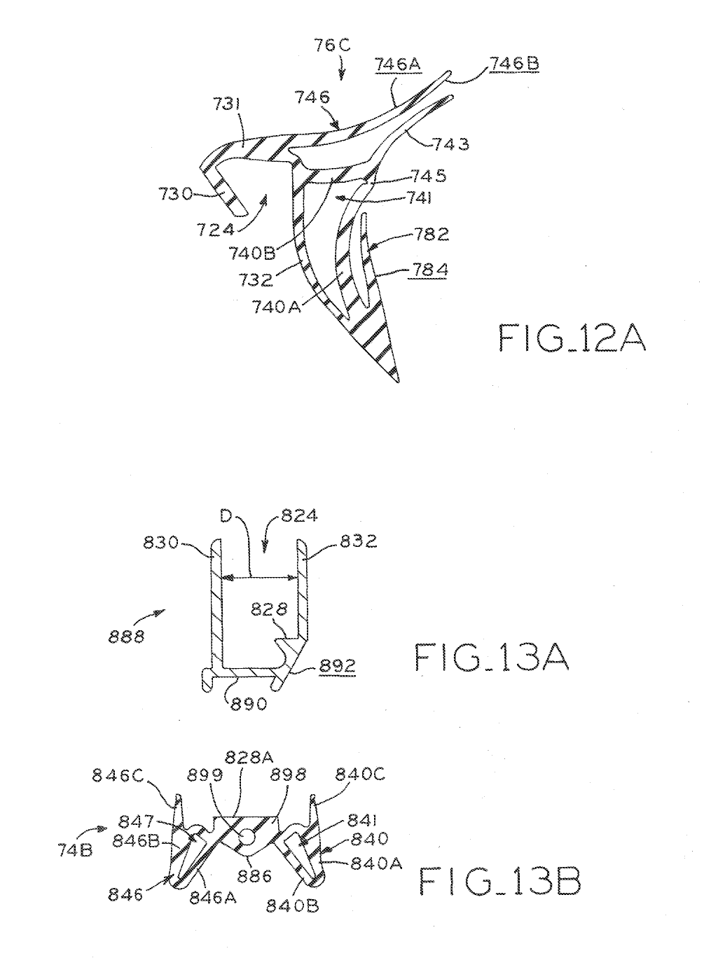

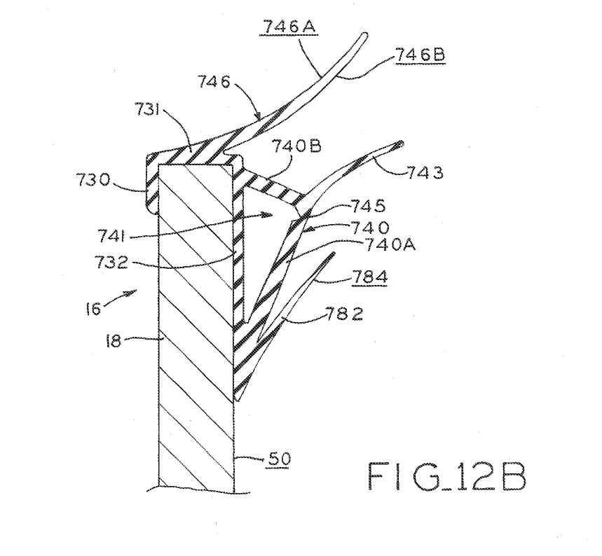

Turning now to FIG. 12, an alternative top seal 76B is illustrated in cross-section. Top seal 76B is structurally and functionally similar to top seal 76A described in detail above, with reference numerals of seal 76B analogous to corresponding reference numerals used in seal 76A, except with 100 added thereto. Structures of seal 76B correspond to similar structures denoted by corresponding reference numerals of seal 76A except as otherwise noted, and seal 76B is amenable to similar methods for installation and use in conjunction with door 16 and door frame 12. In the interest of clarity and conciseness, only those features of seal 76B which differ from the corresponding features of seal 76A are described below, it being understood that all other features of seal 76A may also be present in seal 76B.

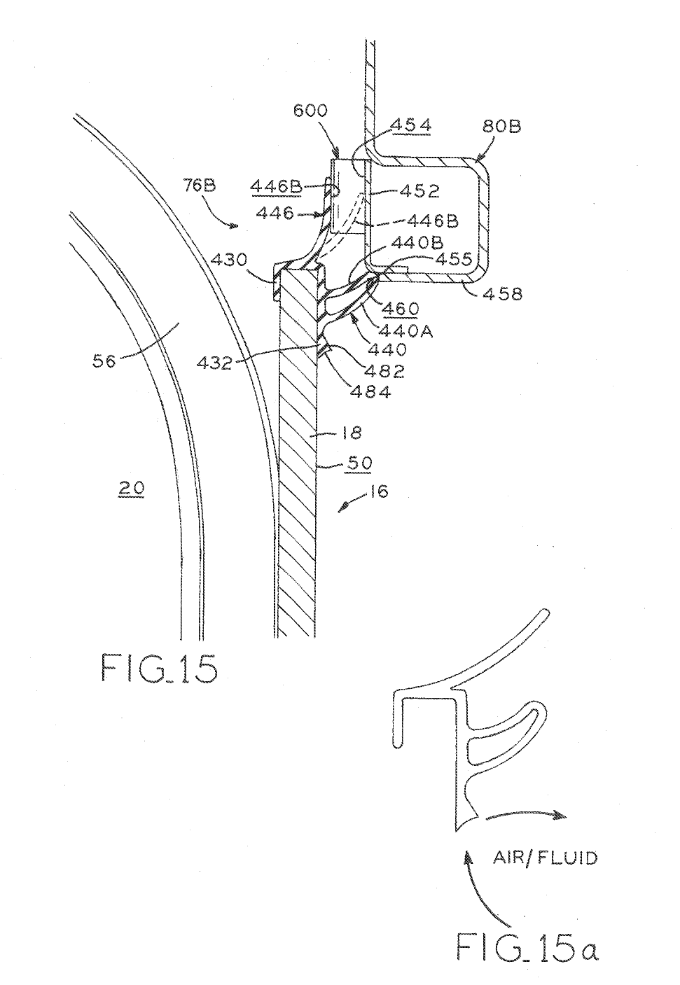

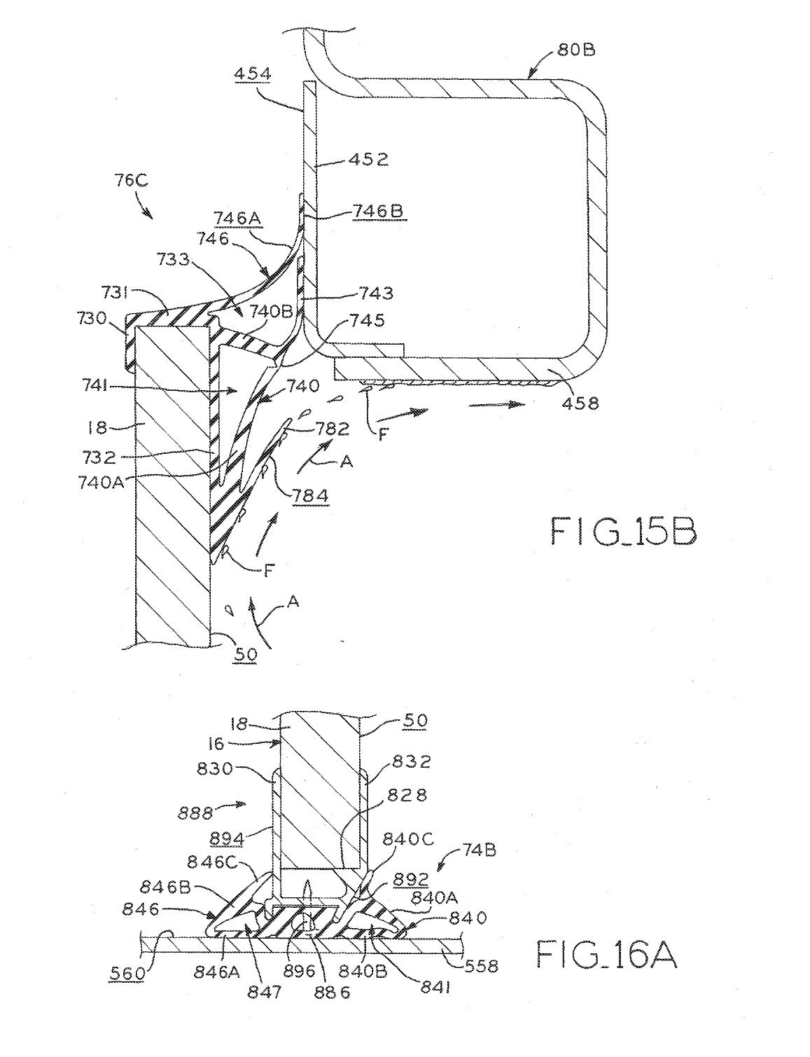

Primary sealing lobe 440 has a similar structure and arrangement as compared to primary sealing lobe 340, except with a modified shape for the features and geometry of upper frame portion 80B (FIG. 15). Moreover, FIGS. 11, 12, 12A, 12B, 13, 13A and 13B are all drawn to scale, and so variations in lobe geometry for primary lobes 340 and 440 are as shown. In the illustrated embodiments of FIGS. 11, 12 and 13 (discussed below), distance D between legs 330, 332, legs 430, 432, legs 530, 532, legs 730, 732, or legs 830, 832 when seals 74A, 74B, 76A, 76B, 76C are mounted upon door 16 is 0.510 inches. Other dimensions of seals 74A, 74B, 76A, 76B, 76C may be measured from the respective figures in view of this relative scale provided by dimension D.

In the case of seal 76B, outer lobe wall 440A includes a slightly convex curvature rounding to a broader point with inner lobe wall 440B, and inner lobe wall 440B defines a slightly concave outer surface.

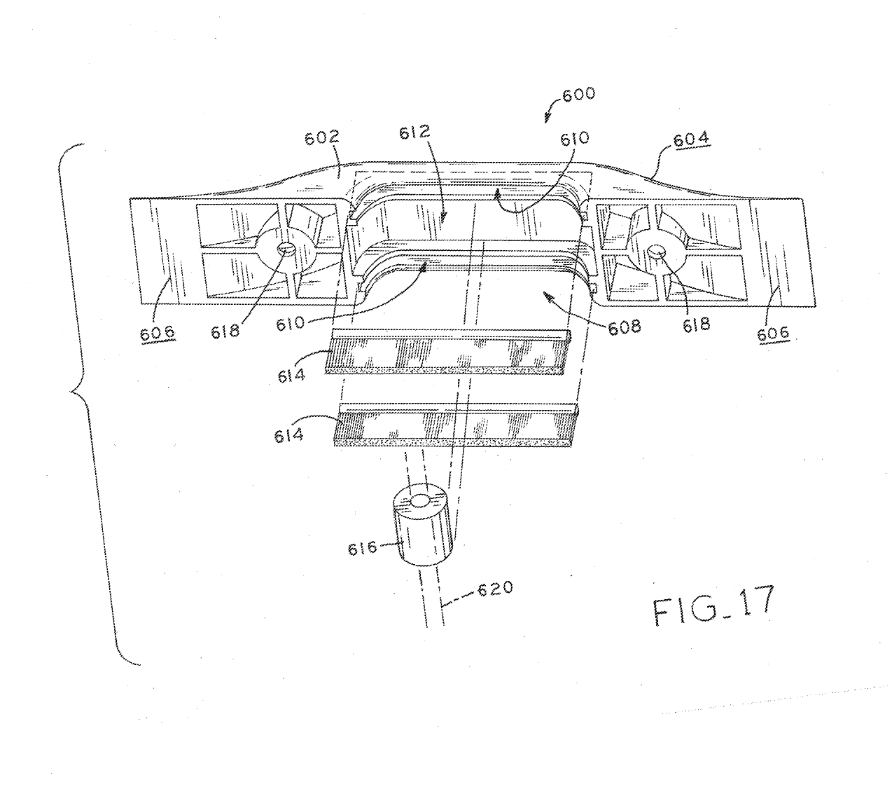

Top seal 76B includes an elongate, fin-like secondary sealing lobe 446 rather than the dual-wall arrangement of sealing lobe 346 shown in FIG. 11 and described in detail above. As described in further detail below, this fin-like sealing lobe 446 is adapted to interact with cable sealing assembly 600 (FIGS. 17-22) to eliminate a potential leak path between cargo space 20 and the ambient environment in the vicinity of upper frame portion 80B.

As shown in FIG. 15, when door 16 is in the closed position such that upper panel 18 is substantially vertical, primary sealing lobe 440 sealing abuts an end surface 460 of horizontal flange 458 of upper frame portion 80B. In addition, L-shaped bracket 452 may be affixed to upper frame portion 80B to provide a horizontal sealing surface 455 against which lobe 440 may also seal. In the illustrated embodiment, a tip of lobe 440 provides a primary seal surface at the junction between outer and inner lobe walls 440A, 440B. It is also contemplated that inner lobe wall 440B may seal on horizontal sealing surface 455 alone, similar to the sealing arrangement of primary sealing lobe 340 described above.

Secondary sealing lobe 446 biases against inwardly facing surface 454 of L-shaped bracket 452 to provide a secondary, redundant seal against ingress of fluids or other contaminants into cargo space 20. More particularly, as shown in the dashed-line configuration of secondary sealing lobe 446 in FIG. 15, outwardly-facing lobe surface 446B sealingly abuts inwardly facing surface 454 to provide such second seal. Lobe 446 also includes inwardly-facing surface 446A (FIG. 12) opposite sealing surface 446B.

Top seal 76B further includes airfoil 482 formed on outer leg 432, as illustrated in FIGS. 12 and 15. Airfoil 482 is formed as an outwardly shaped point with a downwardly facing, slightly concave lower surface 484. As turbulent air passes over the top of cargo box 22 when truck 14 is in transit (i.e., moving forward), turbulent airflows in the vicinity of top seal 76B tend to swirl and drive air and/or precipitation upwardly against upper door panel 18 and upper frame portion 80B. It has been empirically determined that provision of airfoil 482 with concave lower surface 484 produces a “spoiler effect” which diverts this turbulent flow of air and/or precipitation away from primary sealing lobe 440, as illustrated schematically in FIG. 15A. This spoiler effect eliminates a source of potential weathering and high pressure leak potential acting against primary sealing lobe 440.

Although airfoil 482 is shown in the figures as being integrally formed with outer leg 432 of top seal 76B, it is contemplated that a similar structure may be formed as part of outer leg 332 of top seal 76A discussed above. Airfoil 382 having concave lower surface 384 is schematically illustrated in FIG. 11.

Turning now to FIGS. 12A, 12B and 15B, another exemplary top seal 76C is illustrated in as-extruded, mounted at-rest, and engaged configurations, respectively.

Except as otherwise described below, top seal 76C has a number of features similar to top seals 76A and 76B described above, and reference numerals of seal 76C are analogous to corresponding reference numerals used in top seals 76A and 76B except that reference numbers for seal 76C take the form 7XX (e.g., sealing lobe 740) compared to the form 3XX and 4XX used in seals 76A and 76B respectively (e.g., sealing lobes 340, 440 respectively). Structures of seal 76C correspond to similar structures denoted by corresponding reference numerals of seals 76A and 76B except as otherwise noted, and seal 76C is amenable to similar methods for installation and use in conjunction with door 16 and door frame 12. In the interest of clarity and conciseness, only those features of seal 76C which differ from the corresponding features of seals 76A and 76B are described below, it being understood that all other features of seal 76A, 76B may also be present in seal 76C.

However, unlike top seals 76A and 76B, top seal 76C includes two elongate, fin-like sealing lobes 746 and 743 which both engage inner surface 454, together with airfoil lobe 782 which uses expected patterns of airflow A (FIG. 15B) at the rear of cargo box 15 (FIG. 1) to divert a primary portion of the flow of fluid F away from the sealing engagement between lobes 746 and 743 and inner surface 454.

Similar to the other seals described herein, top seal 76C is formed as a unitary, monolithic structure such that its entire cross-sectional shape has a constant durometer throughout. In order to achieve this monolithic form, seal 76C may be extruded from bulk material, such as EPDM, and cut to length for installation on the sides of door 16 as described above. FIG. 12A illustrates seal 76C in its as-extruded form, prior to installation on door 16, while FIG. 12B illustrates seal 76C installed on door 16 but otherwise undeflected. By comparison of FIGS. 12A and 12B, the resilient deflection of seal 76C upon mounting can be appreciated.

As extruded, coupling recess 724 is partially collapsed such that inner leg 730 is angled toward outer leg 732, and outer leg 732 defines a bent “reverse-J-shaped” profile as shown in FIG. 12A. To mount the as-extruded seal 76C to door 16, the lower end of outer leg 732 is first adhesively attached to an appropriate location on outer surface 50 of door 16. Seal 76C is then mounted to the edge of door 16 (FIG. 12B) via legs 730, 732, such that inner leg 730 resiliently deforms to provide a securement force, while coupling portion 731 bridging legs 730, 732 abuts the upper edge of door 16. This attachment resiliently deflects outer leg 732 and the structures attached thereto, such that upper and lower sealing lobes 746, 740 and airfoil lobe 782 are reconfigured from the as-extruded “reverse-J-shape” into a service configuration (FIG. 12B) in which the entirety of outer leg 732 is made substantially straight and drawn against outer surface 50. Adhesive may also be applied between inner leg 730 and the adjacent interior surface of door panel 18 for further securement.

In the service configuration of FIG. 12B, the inverted U-shape of coupling recess 724 is formed by inner leg 730 which forms a junction with the upper bridge 731, and outer leg 732 which forms a junction with at an opposing end of upper bridge 731 opposite inner leg 730. In this way, inner leg 730, outer leg 732 and bridge 731 define the U-shaped door receiving space 724 with an open lower end.

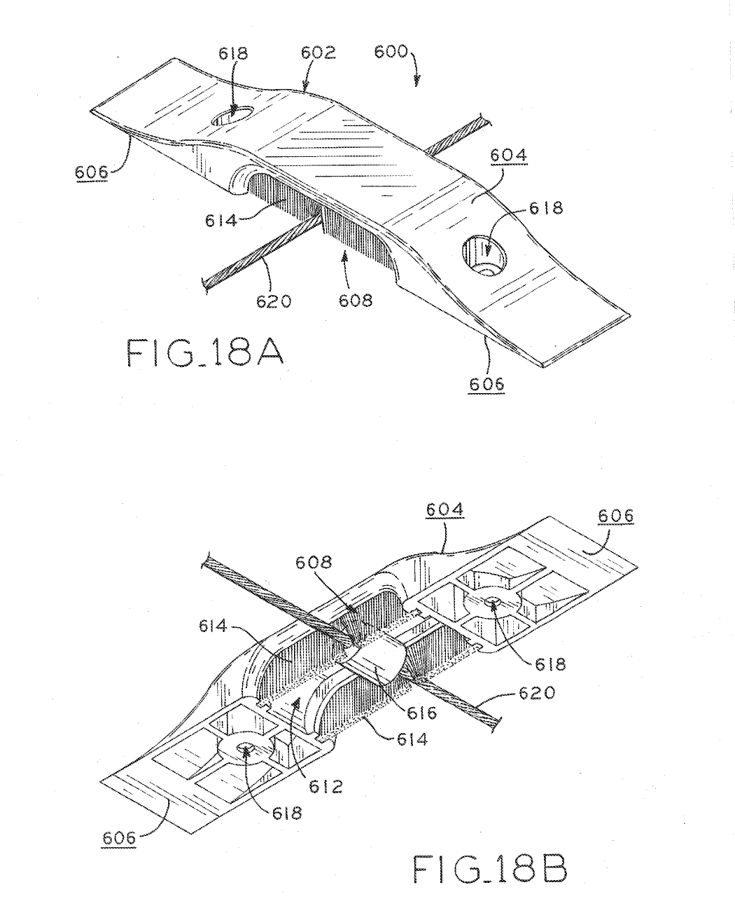

Upper sealing lobe 746 extends laterally and upwardly away with respect to outer leg 732 and, more particularly, sealing lobe 746 extends upwardly and outwardly from its junction with bridge portion 731 as best seen in FIG. 18B. Lower sealing lobe 740 is formed of multiple individual portions, including first lobe wall 740A forming a junction with a lower end of outer leg 732 and extending laterally and upwardly away from outer leg 732, second lobe wall 740B forming a junction with an upper end of outer leg 732 and with the end of first lobe wall 740A, and lobe extension 743 extending laterally and upwardly away from the junction between the first and second lobe walls 740A, 740B. First lobe wall 740A, second lobe wall 740B and outer leg 732 form a triangular lobe structure which provides a base of structural support for lobe extension 743, such that lobe extension 743 can resiliently bias against sealing surface 454 as shown in FIG. 15B and described further below.

In an exemplary embodiment, living hinge 745 is formed in first lobe wall 740A adjacent to and just below the junction between first and second lobe walls 740A and 740B. Living hinge 745 facilitates resilient deflection of the triangular lobe structure in a predictable manner to provide the desired kind and character of resilient support to lobe extension 743 for a firm seal with sealing surface 454 (FIG. 15B).

As noted above, top seal 76C also includes airfoil lobe 782, which operates to direct a flow of water F and air A upwardly and away from the upper and lower sealing lobes. Airfoil lobe 782 forms a junction with a lower end of outer leg 732, as well as with first lobe wall 740A, and is positioned below lower sealing lobe 740 while extending generally laterally and upwardly away from outer leg 732 in a similar fashion to sealing lobes 746, 743. However, airfoil lobe stops short of contact with any portion of upper frame portion 80B, and therefore does not participate in the structural deflection characteristics of lobes 740, 746. In an exemplary embodiment, airfoil lobe 782 defines a concave surface 784 facing outwardly and downwardly which directs water F along the illustrated trajectory toward contact with horizontal flange 458 of upper frame portion 80B, where airflow A carries water F rearwardly and away from cargo box 15. In this way, airfoil lobe 782 substantially prevents the ingress of rainwater at the sealing engagement between lower and upper sealing lobes 743, 746 and sealing surface 454.

Meanwhile, lobes 740, 746 cooperate to present a large-area sealing engagement with sealing surface 454 of bracket 452, thereby providing a fluid-tight seal to prevent any fluid (e.g., air, water, or airborne particulate matter) from passing between the interior and exterior of cargo box 15 along the upper edge of door 16. In addition, the illustrated arrangement of lower and upper sealing lobes 740, 746 cooperates with bracket 452 (or any other adjacent substantially vertical sealing surface) to create air pocket 733, which is a “dead air” space that insulates the sealing engagement between lobe 746 and sealing surface 454 from wind and turbulence outside cargo box 15.

3. Bottom Seal

Turning now to FIG. 13, bottom seal 74A is illustrated. Similar to top seals 76A, 76B, bottom seal includes inner and outer legs 530, 532 which span seating surface 528, all of which cooperate to form coupling recess 524 sized and adapted to attach bottom seal 74A to a bottom edge of a lower surface panel 18 of door 16, in similar fashion to the manner of connection for top seals 76A, 76B to the upper edge of the upper most panel 18 of door 16.

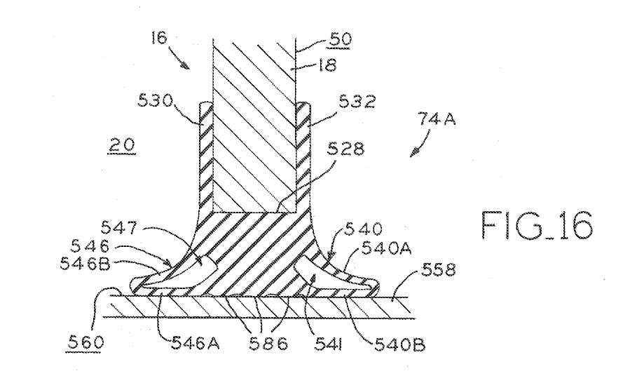

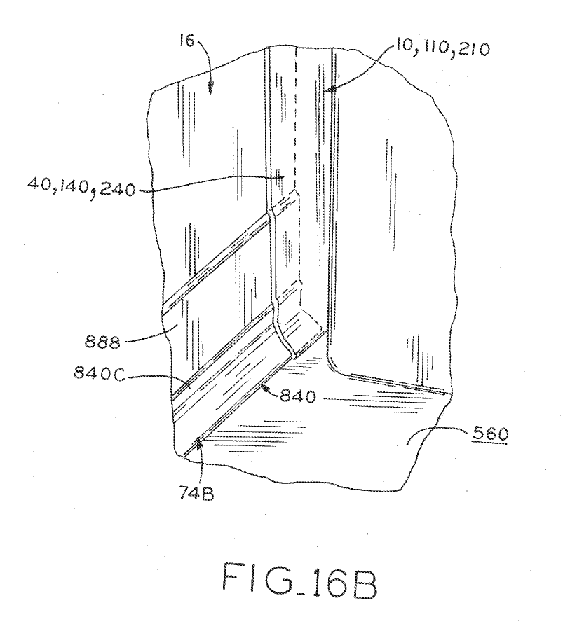

Bottom seal includes outer sealing lobe 540 and inner sealing lobe 546, which may be substantial mirror images of one another as illustrated in FIG. 13. Lobes 540, 546 include sealing lobe walls 540B, 546A respectively which, when door 16 is in the closed position, engage upper surface 560 of lower frame portion 558 of door frame 12, as shown in FIG. 16. Similar to top seals 76A, 76B above, this deformation alters the shape and configuration of apertures 541, 547 and non-contacting lobe walls 540A, 546B, respectively. In addition, bottom seal 74A may include a plurality (such as three shown in FIGS. 13 and 16) of auxiliary sealing lobes 586 which also resiliently deform in sealing engagement with lower frame portion 558 when in contact with upper surface 560 thereof

Turning to FIGS. 13B and 16A, an alternative bottom seal 74B is shown. Except as otherwise described below, bottom seal 74B has a number of features similar to bottom seal 74A and the other seals described above, and reference numerals of seal 74B are analogous to corresponding reference numerals used in seals 74A and the other seals described herein, except that reference numbers for seal 74B take the form 8XX (e.g., sealing lobe 840) compared to the form 5XX used in seal 74A (e.g., sealing lobe 540). Structures of seal 74B correspond to similar structures denoted by corresponding reference numerals of seals 74A and the other seals described herein except as otherwise noted.

Unlike other seals described herein, bottom seal 74B mounts to the bottom edge of door 16 via a coupler 888, which in the illustrated embodiment takes the form of an aluminum extrusion having the cross-sectional profile shown in FIG. 13A. Coupler 888 includes inner and outer legs 830, 832 which are spaced apart by distance D (described above) in order to mount to door 16 as shown in FIG. 16A. Seating surface 828 forms a shelf adjacent to outer leg 832, which provides for inwardly angled surface 892 at the bottom of outer leg 832 as further described below. A seal receiving space 890 is shaped and sized to receive a correspondingly sized coupling portion 898 of seal 74B. Seal 74B can be fixed to coupler 888 by adhesive between upper surface 828A and the abutting surface of seal receiving space 890, and/or by periodic fasteners, such as nail 896, driven through seal 74B and the lower wall of coupler 888 (FIG. 16A).

Bottom seal 74B includes a primary outer sealing lobe 840, having inner lobe wall 840B and outer lobe wall 840A, and a secondary inner sealing lobe 846 having outer lobe wall 846A and inner lobe wall 846B. Lobes 840, 846 define apertures 841, 847 respectively in cross-section, each aperture sized and positioned to compress when the auxiliary sealing lobe is deformed by contact with an adjacent sealing surface (FIG. 16A).

Primary lobe extension 840C extends upwardly from primary sealing lobe 840, and is joined to an upper end of outer lobe wall 840A as shown in FIG. 13B. Similarly, secondary lobe extension 846C extends upwardly from secondary sealing lobe 846, and is joined to an upper end of inner lobe wall 846B. As described further below, primary and secondary lobe extensions 840C, 846C are sized and arranged to contact an outer surface of the coupler when the primary sealing lobe is deformed by contact with an adjacent sealing surface (FIG. 16A). In an exemplary embodiment, bottom seal is substantially symmetrical about a bisecting vertical plane such that outer and inner sealing lobes 840, 846 are mirror images of one another.

Auxiliary sealing lobe 886 is disposed between outer and inner lobes 840 and 846 and extends downwardly from coupling portion 898. Aperture 899 may be formed in coupling portion 898, as view in cross section (FIG. 13B) which is sized and positioned to compress when auxiliary sealing lobe 886 is deformed by contact with an adjacent sealing surface (FIG. 16A).

In use, door 16 advances downwardly until lobes 840, 846 contact upper surface 560 of lower frame portion 558 of door frame 12, as shown in FIG. 16A. As lobe 840 deflects upwardly, lobe extension 804C contacts ramped surface 892 of coupler 888 and is resiliently deflected to established a large-area seal therebetween. At the same time, secondary lobe extension 846 also comes in to contact with coupler 888 at inner surface 894, but makes a lesser area of contact. The outer seal lobe extension 840C therefore provides a primary seal between the outside and inside of cargo box 15, while the inner lobe extension 846C makes a secondary area of contact for a redundant seal. Yet another redundant sealing contact is made between auxiliary lobe 886 and upper surface 560.

4. Cable Seal

Turning now to FIGS. 17-19, cable sealing assembly 600 is illustrated. As best seen in FIG. 17, cable sealing assembly 600 includes bracket 602 having a smooth, arcuate outer surface 604 and a pair of opposing, substantially planar mounting surfaces 606. In between respective mounting surfaces 606 is a cable passage area 608 which includes brush seal mounting grooves 610 and bushing roller groove 612. As illustrated by a comparison of the exploded view of FIG. 17 with the assembled view of FIG. 18B, brush seals 614 are interfittingly received within respective brush seal mounting grooves 610, while cable bushing 616 is received within roller groove 612 and between brush seals 614. In an exemplary embodiment, cable bushing 616 is a two-piece arrangement split along the longitudinal axis thereof to facilitate attachment to cable 620.

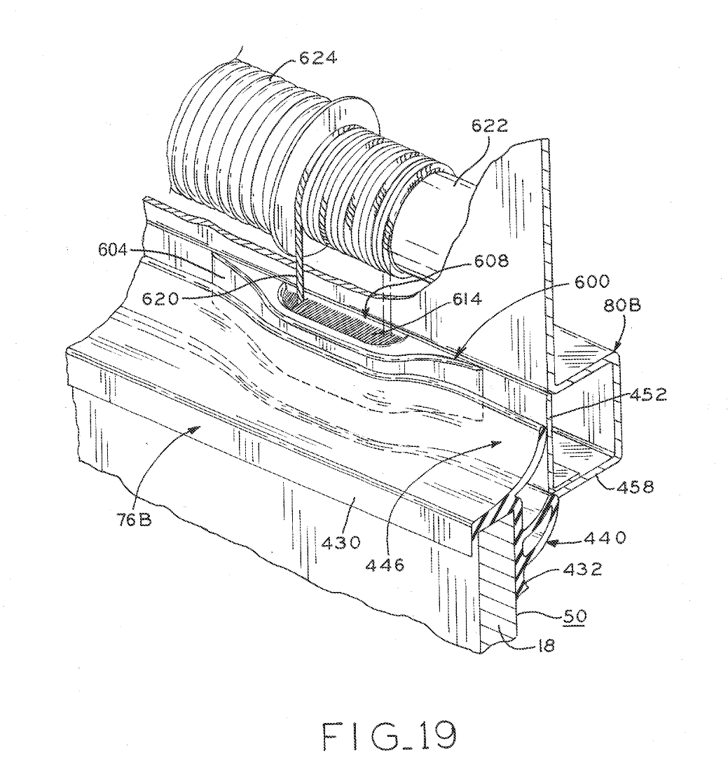

Bracket 602 includes mounting apertures 618 extending from arcuate outer surface 604 through planar mounting surfaces 606. As shown in FIG. 19, as well as in FIG. 15, cable sealing assembly 600 mounts to upper frame portion 80B at vertical surface 454 by passing fasteners through apertures 618 and into the underlying frame material.

Cable 620 is received through a central aperture of cable bushing 616 and passes through each of the adjacent brush seals 614, as best seen in FIG. 18B. In the context of truck 14 (FIG. 1), cable 620 is wound upon cable spool 622 (FIG. 19), which in turn is fixed to torsion spring 624 mounted adjacent upper frame portion 80B. Torsion spring 624 may contain stored mechanical energy when door 16 is in the closed position, which energy is released to assist in the upward movement of door 16 to the open position in known fashion. That is, as door 16 is opened, cable 620 (which is attached to one of the lower panels 18 of door 16) transmits the torsion force of spring 624 to door 16 as cable 620 spools onto cable spool 622.

Because cable 620 is located between door 16 and the ambient outside environment, but spring 624 is located within cargo space 20 of cargo box 22, the passage of cable from the outside environment into cargo space 20 creates a potential leak path. In order to seal this leak path, cable sealing assembly 600 provides brush seals 614 to prevent or inhibit the flow of air past cable 620. At the same time, the smooth, gradually transitioning arcuate profile of outer surface 604 of bracket 602 provides a sealing surface upon which sealing lobe 446 of top seal 76B can be consistently sealingly engaged. In this way such, the sealing engagement of seal 76B with inwardly facing surface 454 is not interrupted by cable 620. That is to say, referring to FIGS. 15 and 19, sealing surface 446B of lobe 446 may sealingly engage with surface 454 of bracket 452 on either side of cable sealing assembly 600, while also sealingly engaging with the entire longitudinal arcuate extent of arcuate outer surface 604 of bracket 602, thereby creating an uninterrupted upper sealing engagement between top seal 76B and upper frame portion 80B. In the case of top seal 76C, similar engagement occurs between lobes 740, 746 and outer surface 604 of bracket 602. Meanwhile, as noted above, brush seals 614 provide a seal for cable passage area 608 to also prevent ingress of fluid or contaminants into cargo space 20 from the ambient environment.

Because cable 620 is spooled along spool 622, cable 620 may move laterally during the opening or closing of door 16. In order to accommodate this lateral movement, cable 620 is received within cable bushing 616, which rolls freely within roller groove 612. As cable 620 moves laterally during the spooling process, cable bushing 616 facilitates such lateral movement while the individual bristles of brush seals 614 continuously engage and substantially envelop cable 620 to maintain the sealing engagement therewith.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A sealing system for sealing a perimeter of a roll-up door and door frame, the sealing system comprising:
a top seal comprising:
a coupling portion comprising an upper bridge, an inner leg forming a junction with the upper bridge, and an outer leg forming a junction with the upper bridge opposite the inner leg, such that the inner leg, the outer leg and the upper bridge define a U-shaped door receiving space with an open lower end;
an upper sealing lobe extending laterally and upwardly away from the outer leg; and
a lower sealing lobe forming a junction with the outer leg and extending laterally and upwardly away from the outer leg, the lower sealing lobe disposed below the upper sealing lobe.

2. The sealing system of claim 1, wherein the upper sealing lobe forms a junction with the upper bridge.

3. The sealing system of claim 1, wherein the lower sealing lobe comprises:
a first lobe wall forming a junction with a lower end of the outer leg, the first lobe wall extending laterally and upwardly away from the outer leg;
a second lobe wall forming a junction with an upper end of the outer leg and with the first lobe wall, such that the first lobe wall, second lobe wall and outer leg form a triangular lobe; and
a lobe extension extending laterally and upwardly away from the junction between the first and second lobe walls.

4. The sealing system of claim 3, wherein the junction between the first and second lobe walls includes a living hinge to facilitate resilient deflection of the triangular lobe.

5. The sealing system of claim 1, further comprising an airfoil lobe forming a junction with the outer leg at a position below the lower sealing lobe, the airfoil lobe extending laterally and upwardly away from the outer leg.

6. The sealing system of claim 5, wherein the airfoil lobe defines a concave surface facing outwardly and downwardly, the concave surface sized and positioned to direct a flow of water and air upwardly and away from the upper and lower sealing lobes.

7. The sealing system of claim 5, wherein the coupling portion, the upper sealing lobe, the lower sealing lobe and the airfoil lobe are formed from a single monolithic material.

8. The sealing system of claim 1, wherein the coupling portion, the upper sealing lobe and the lower sealing lobe are formed from a single monolithic material.

9. The sealing system of claim 1, further comprising a bottom seal assembly comprising:
a coupler comprising:
a pair of legs sized to be received over an edge of a panel of the roll-up door; and
a seal receiving surface facing downwardly away from the pair of legs;
a bottom seal comprising:
a coupling portion having a coupling surface adapted to affix to the seal receiving surface such that the bottom seal is affixed to the coupler;
a primary sealing lobe extending outwardly from the coupling portion of the bottom seal; and
a secondary sealing lobe extending inwardly from the coupling portion of the bottom seal.

10. The sealing system of claim 9, wherein the bottom seal further comprises at least one auxiliary sealing lobe disposed between the primary sealing lobe and the secondary sealing lobe, the auxiliary sealing lobe extending downwardly from the coupling portion of the bottom seal.

11. The sealing system of claim 10, wherein the coupling portion of the bottom seal includes an aperture in cross-section, the aperture sized and positioned to compress when the auxiliary sealing lobe is deformed by contact with an adjacent sealing surface.

12. The sealing system of claim 9, wherein the primary sealing lobe further comprises a primary lobe extension extending upwardly from the primary sealing lobe, the primary lobe extension sized and arranged to contact an outer surface of the coupler when the primary sealing lobe is deformed by contact with an adjacent sealing surface.

13. The sealing system of claim 12, wherein the coupler includes an inwardly angled outer surface positioned to receive the primary lobe extension, such that a contact seal area is established between the angled outer surface and the primary lobe extension when the secondary sealing lobe is deformed by contact with an adjacent sealing surface.

14. The sealing system of claim 12, wherein the secondary sealing lobe further comprises a secondary lobe extension extending upwardly from the secondary sealing lobe, the secondary lobe extension sized and arranged to contact an inner surface of the coupler when the secondary sealing lobe is deformed by contact with an adjacent sealing surface.

15. The sealing system of claim 9, wherein the primary and secondary sealing lobes each have apertures in cross-section, the apertures each sized and positioned to allow the primary and secondary sealing lobes to resiliently deflect when the primary and secondary sealing lobes are deformed by contact with an adjacent sealing surface.

16. The sealing system of claim 9, further comprising at least one side seal adapted to extend between the top seal and the bottom seal, the side seal comprising:
a coupling body comprising a seating surface and an exposed surface opposite the seating surface, a pair of opposed side surfaces extending between the seating surface and the exposed surface, a longitudinal body axis extending from the seating surface to the exposed surface between the pair of opposed side surfaces; and
a main sealing lobe extending from the exposed surface of the coupling body, the main sealing lobe having an arcuate cross-sectional profile defining a concave inner surface and an opposing convex outer surface such that the main sealing lobe is adapted to bias against an adjacent door surface.

17. The sealing system of claim 16, wherein the main sealing lobe of the side seal extends downwardly over the primary sealing lobe to form a corner seal.

18. The sealing system of claim 1, further comprising a cable sealing assembly comprising:
a bracket having a mounting surface and an opposing, arcuate outer surface, the arcuate outer surface adapted to form a continuous sealing arrangement with at least one of the upper and lower sealing lobes of the top seal; and
a cable passage area between the mounting surface and the arcuate outer surface.

19. The sealing system of claim 18, wherein the bracket includes a roller groove formed adjacent the cable passage area and behind the arcuate outer surface, the cable sealing assembly further comprising a cable bushing rollingly received within the roller groove to provide a low-friction translation of a cable through the cable passage area.

20. The sealing system of claim 19, further comprising at least one brush seal disposed in the cable passage area and along the roller groove.

21. A sealing system for sealing a perimeter of a roll-up door and door frame, the sealing system comprising:
a bottom seal comprising:
a coupling portion having a coupling surface;
a primary sealing lobe extending outwardly from the coupling portion, the primary sealing lobe comprising a primary lobe extension extending upwardly from the primary sealing lobe;
a secondary sealing lobe extending inwardly from the coupling portion, the secondary sealing lobe comprising a secondary lobe extension extending upwardly from the secondary sealing lobe.

22. A sealing system for sealing a perimeter of a roll-up door and door frame, the sealing system comprising:
a top seal having a resiliently deformable seal lobe;
a cable sealing assembly comprising
a bracket having a mounting surface and an opposing, arcuate outer surface, the arcuate outer surface adapted to form a continuous sealing arrangement the resiliently deformable seal lobe; and
a cable passage area between the mounting surface and the arcuate outer surface.

23. The sealing system of claim 22, wherein the bracket includes a roller groove formed adjacent the cable passage area and behind the arcuate outer surface, the cable sealing assembly further comprising a cable bushing rollingly received within the roller groove to provide a low-friction translation of a cable through the cable passage area.

24. The sealing system of claim 23, further comprising at least one brush seal disposed in the cable passage area and along the roller groove.
